(19) United States
(12) Patent Application Publication
(10) Pub. No.: US 2005/0087652 A1
(43) Pub. Date: Apr. 28, 2005

(54) Emergency parachute system for helicopters

(76) Inventor: Mike Holmboe, San Jose, CA (US)

Correspondence Address: Mike Holmboe, 1500 Norman Ave., San Jose, CA, 95125, US

(21) Appl. No.: 10/975,301

(22) Filed: Oct. 27, 2004

Related U.S. Application Data
(60) Provisional application No. 60/514,839, filed on Oct. 27, 2003.

(51) Int. Cl. B64D 17/00; B64D 19/00

(52) U.S. Cl. 244/139

(57) ABSTRACT

An emergency parachute system for helicopters includes a main parachute tube attached to a helicopter tail boom distal of a helicopter main rotor and tail rotor, the main parachute tube housing a main parachute, a rocket tube housing a rocket, the rocket tube disposed on the main parachute tube, the rocket attached to the main parachute, a pilot parachute tube housing a pilot parachute, the pilot parachute tube disposed on the main parachute tube, the pilot parachute attached to the tail boom, and control means for deploying the pilot parachute and the rocket.

### BACKGROUND OF THE INVENTION

This invention relates to emergency parachute systems for helicopters and more particularly to an emergency parachute system for helicopters having a deployable pilot parachute and a rocket deployed main parachute, the system being disposed on a tail boom of a helicopter distal of the main rotor and tail rotor.

In the field of general aviation, helicopters statistically have had a sub-par safety record when compared to that of their airplane cousins. And even though helicopters might not be as statistically-safe as flying in a fixed-wing aircraft, helicopters do have basic safety features built into them. For example, if something unforeseen were to happen to the helicopter (i.e., an engine failure), it can “glide” (or autorotate) and land safely if the pilot has enough airspeed and/or altitude to work with. There are several factors however that can keep a pilot from performing a safe autorotation. These factors can range from pilot error to some type of catastrophic mechanical failure, sometimes with one factor leading to the other. For example, in the case of an engine failure, if the pilot does not properly initiate an autorotation (by immediately lowering the collective), the helicopter's rotor rpm will quickly decay to a critical level and will be unrecoverable. Furthermore, while the helicopter is in this low-rotor-rpm situation, the chances of it experiencing a catastrophic main rotor/tail boom strike increases dramatically.

Therefore, having a supplemental parachute safety system could be very useful to helicopter pilots. The fundamental problem with simply mounting and deploying a parachute from a falling, incapacitated helicopter is that when a helicopter falls, it tends to tumble randomly. If one were to try and deploy a parachute in this condition, there would be a high risk of entangling the parachute (and its riggings) in the helicopter's spinning rotor blades, which would effectively render the parachute useless. So in addition to the parachute requiring enough altitude to deploy, one must first find a way to either stop the rotors from spinning (as described in the prior art), or, to orient the helicopter in such a manner that a deployed parachute won't come into contact with the rotor blades.

Emergency parachute systems for helicopters are well known in the prior art. For example, U.S. Pat. No. 5,836,544 entitled “Emergency Soft-Landing System for Rotor-Type Aircraft” discloses a system including at least one parachute-containing structure that houses at least one parachute. The structure is designed to be selectively attached to various locations on the helicopter's lower surface, the sides, and to the landing gear struts. The parachute is deployed from the structure when an out-of-control landing is unavoidable or an extreme emergency exists. The system can be designed so that the parachute-containing structure operates in combination with an airbag.

U.S. Pat. No. 6,199,799 entitled “Parachute Device for Helicopters” discloses a parachute device including a canopy confining case having a stationary casing part, and a removable casing part mounted removably on the stationary casing part. The stationary and removable casing parts cooperatively form a compartment to receive a parachute canopy that has a release cord connected to the removable casing part, and a suspension line unit. An anchoring line has one end that extends into the canopy confining case and that is coupled to the suspension line unit of the parachute canopy. A rocket member includes a launch tube mounted on the stationary casing part externally of the compartment, and a rocket disposed in the launch tube and connected to the removable casing part. The rocket is capable of propelling from the launch tube when ignited. An ignition control line has a first end connected to the rocket member, and a second end provided with an ignition unit that is operable so as to ignite the rocket. The device further includes a mounting member adapted to be extended rotatably inside a rotor drive shaft of a helicopter.

U.S. Pat. No. 6,382,558 entitled “Safety System for a Helicopter” discloses a safety system including a parachute mounted within a cylinder located in a hollow drive shaft of a propeller or in an external container. Four auxiliary parachutes are located in front and behind, and to the left and right of the propeller. The propeller may be locked in a predetermined angular position by a braking system of the drive shaft when the helicopter is disabled in an air accident such that the auxiliary parachutes are located in the spaces between the propeller blades for their safe deployment for suspending the helicopter in air. Speed reducing jets are provided for reducing the falling speed of the helicopter and for landing it safely on the ground. Inflatable bags are provided for maintaining the helicopter afloat when it falls onto a body of water or to cushion its landing impact on the ground.

As can be seen, there is a need for an emergency parachute system for helicopters having a deployable pilot parachute and a rocket deployed main parachute, the system being disposed on a tail boom of a helicopter distal of the main rotor and tail rotor. Such a system preferably provides a means by which the helicopter can be oriented before deployment of the main parachute such that the main parachute is not struck by either the main rotor or the tail rotor of the helicopter. Such a system also preferably is easily mountable to a helicopter tail boom. Such a system also preferably is easy to operate.

### SUMMARY OF THE INVENTION

In accordance with the present invention, an emergency parachute system for helicopters includes a main parachute tube attached to a helicopter tail boom distal of a helicopter main rotor and tail rotor, the main parachute tube housing a main parachute, a rocket tube housing a rocket, the rocket tube disposed on the main parachute tube, the rocket attached to the main parachute, a pilot parachute tube housing a pilot parachute, the pilot parachute tube disposed on the main parachute tube, the pilot parachute attached to the tail boom, and control means for deploying the pilot parachute and the rocket.

In accordance with an alternate embodiment of the present invention, a safety apparatus for use with a helicopter having a frame, a tail boom, a main rotor, a vertical stabilizer, and a tail rotor includes a main parachute tube attached to the helicopter tail boom distal of the helicopter main rotor and tail rotor, the main parachute tube housing a main parachute, a rocket tube housing a rocket, the rocket tube disposed on the main parachute tube distal of the vertical stabilizer and tail rotor, the rocket attached to the main parachute, a pilot parachute tube housing a pilot parachute, the pilot parachute tube disposed on the main parachute tube distal of the vertical stabilizer and tail rotor, the pilot parachute attached to the frame, and a control cable for deploying the pilot parachute, a control cable for releasing the pilot parachute, and a control cable for deploying the rocket.

In accordance with an alternate embodiment of the present invention, a method of providing safety to a helicopter having a frame, a tail boom, a main rotor, a vertical stabilizer, and a tail rotor includes the steps of deploying a pilot parachute attached to the helicopter frame, the pilot parachute being attached distally of the helicopter main rotor, vertical stabilizer and tail rotor, releasing the pilot parachute when the helicopter tail boom is pointed upward relative to a falling direction, and deploying a rocket attached to a main parachute, the main parachute being attached to the helicopter frame.

These and other features, aspects and advantages of the present invention will become better understood with reference to the following drawings, description and claims.

### BRIEF DESCRIPTION OF THE DRAWINGS

FIG. 1 is a side elevation view of an emergency parachute system for helicopters disposed on a starboard side of a helicopter tail boom in accordance with an embodiment of the invention;

FIG. 2 is a side elevation view of the emergency parachute system for helicopters from the port side of the helicopter tail boom in accordance with an embodiment of the invention;

FIG. 3 is a side elevation view of the emergency parachute system for helicopters showing control cables and a safety cable in accordance with an embodiment of the invention;

FIG. 4 is a side elevation view of the emergency parachute system for helicopters showing a main parachute housing aperture in accordance with an embodiment of the invention;

FIG. 5 is a plan view showing a first end portion of a main parachute housing of the emergency parachute system for helicopters in accordance with an embodiment of the invention;

FIG. 6 is a top elevation view of the emergency parachute system for helicopters in accordance with an embodiment of the invention;

FIG. 7 is a top elevation view, partly in section, of the emergency parachute system for helicopters in accordance with an embodiment of the invention;

FIG. 8 is a cross sectional view of a second end portion of the main parachute housing of the emergency parachute system for helicopters in accordance with an embodiment of the invention;

FIG. 9 is a cross sectional view of the main parachute housing showing a main parachute tube and a rocket tube;

FIG. 10 is a cross sectional view of the main parachute housing showing the main parachute tube and a pilot parachute tube;

FIG. 11 is a plan view of the pilot parachute in a released position in accordance with an embodiment of the invention;

FIG. 12 is a plan view of the pilot parachute in an opened position in accordance with an embodiment of the invention;

FIG. 13 is a side elevation view of a three-function control handle mechanism in accordance with an embodiment of the invention;

FIG. 14 is a top elevation view of the three function control handle mechanism in accordance with an embodiment of the invention;

FIG. 15 is a graphical illustration of the operation of the emergency parachute system for helicopters.

### DETAILED DESCRIPTION OF THE INVENTION

The following detailed description is of the best currently contemplated modes of carrying out the present invention. The description is not to be taken in a limiting sense, but is made merely for the purpose of illustrating the general principles of the invention, since the scope of the invention is best defined by the appended claims.

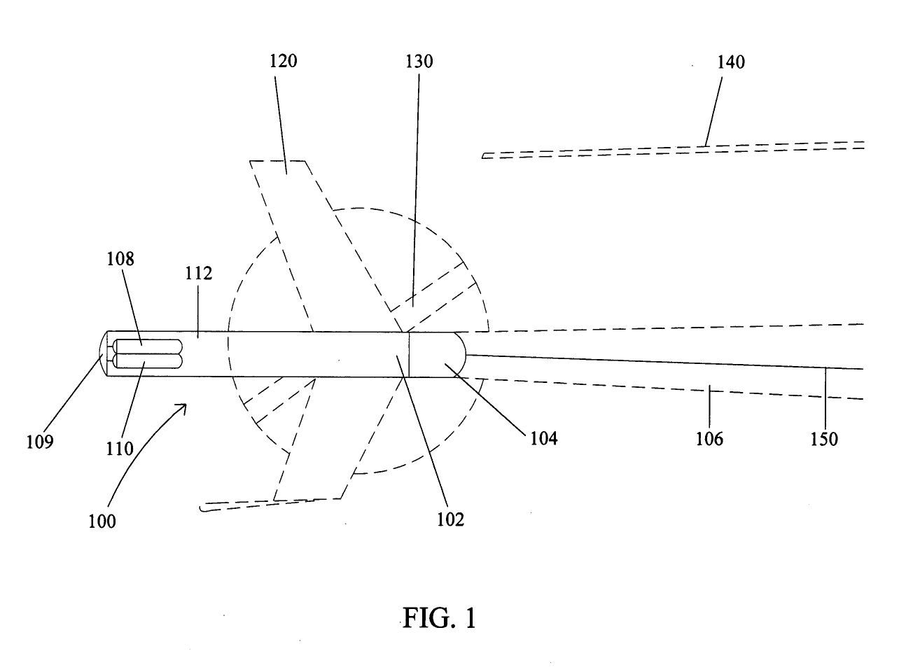

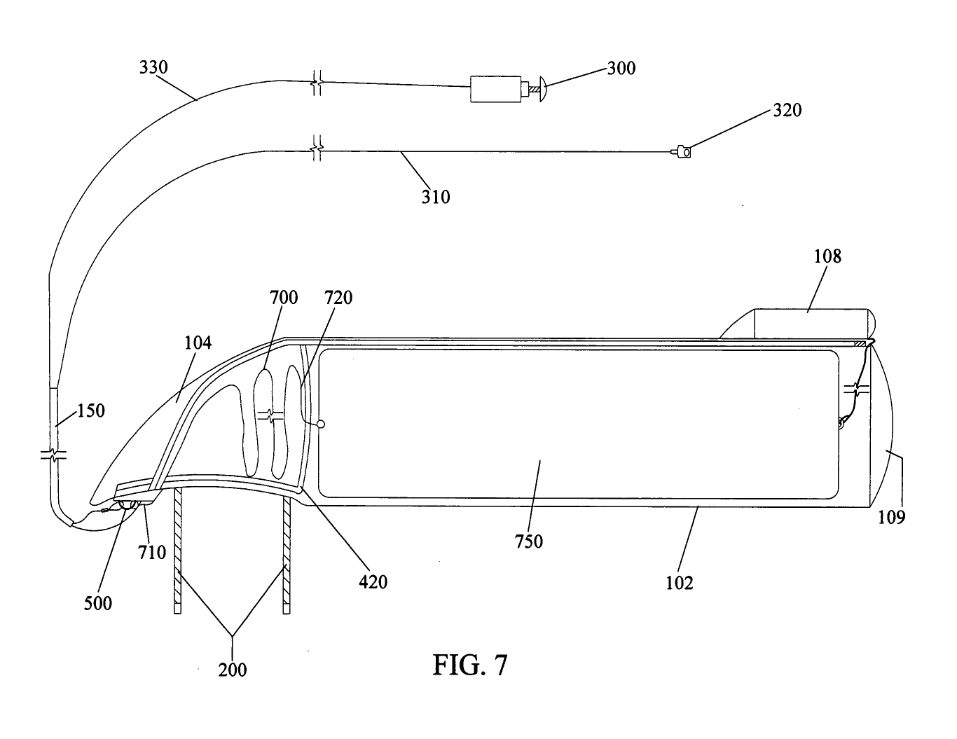

Referring now to the drawings in detail, and particularly FIG. 1, a preferred embodiment of a emergency parachute system for helicopters generally designated 100 is shown including an elongated main parachute housing 102 having a fairing portion 104. The main parachute tube 102 may be disposed on a helicopter tail boom 106 distal of a helicopter's main rotor 140 and tail rotor 130 and controllable from a helicopter cockpit (not shown) by means of control cables disposed inside a sheath 150 as further described herein. Sheath 150 may be disposed along the tail boom 106 opposite a position where a main rotor 140 tail boom strike would likely occur. In this manner the tail boom 106 may absorb most of the impact and shield the sheath 150 from damage. A main parachute tube cap 109 may be provided at a second end portion of the main parachute housing 112 and may be adapted to secure a main parachute 750 (FIG. 7) within the tube 102 as further described herein.

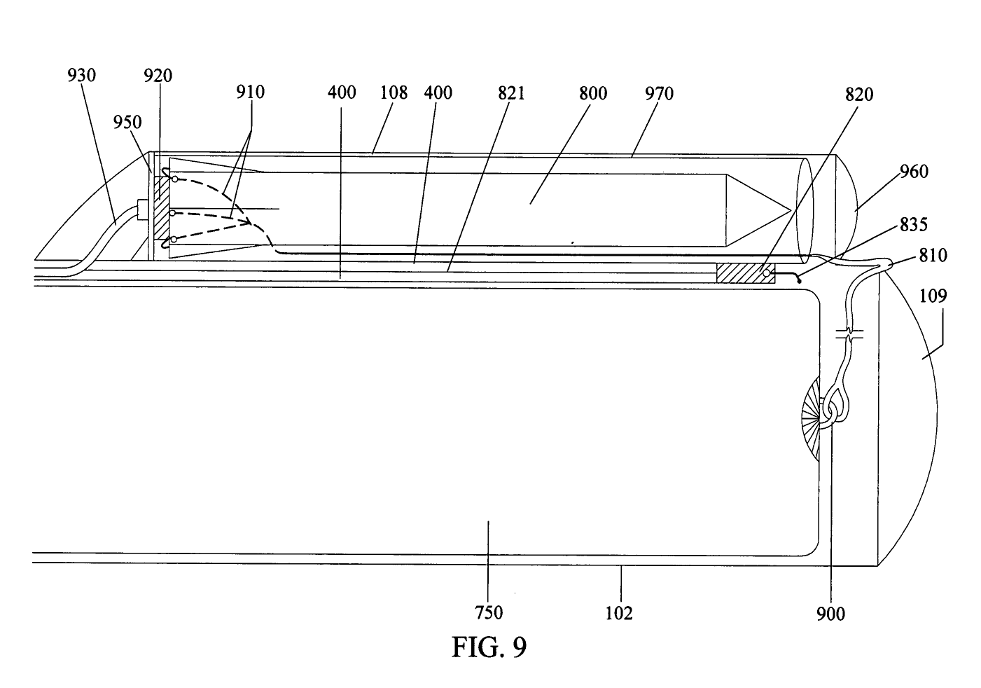

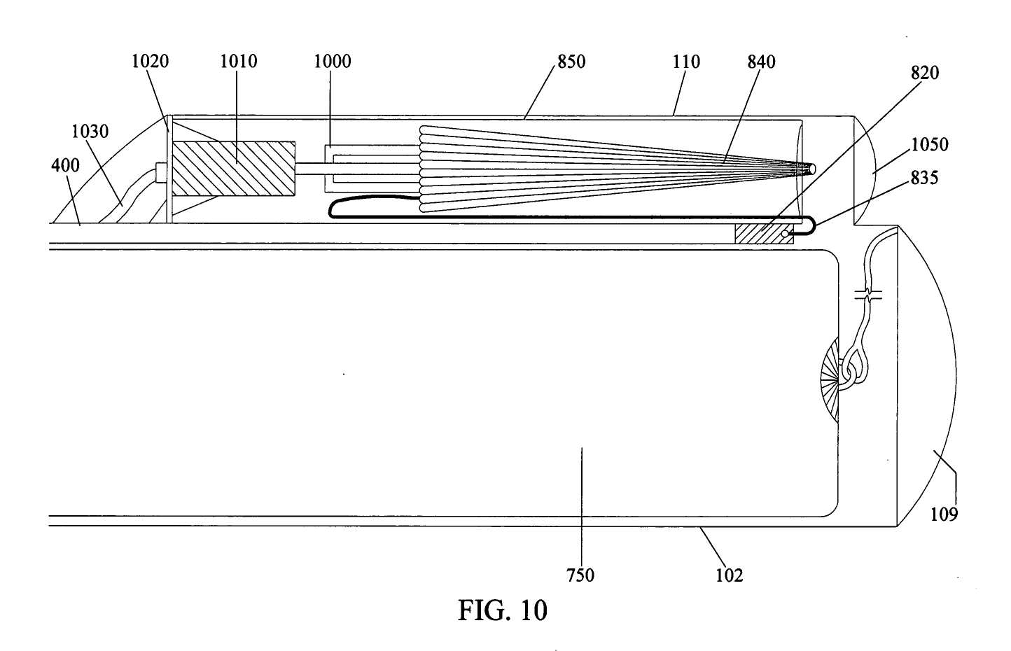

The main parachute tube 102 may include a rocket tube 108 and a pilot parachute tube 110 disposed on the second end portion of the main parachute housing 112. Rocket tube 108 and pilot parachute tube 110 are adapted to house a rocket and a pilot parachute respectively as further described with reference to FIGS. 9 and 10. While rocket tube 108 and pilot parachute tube 110 are shown disposed with the rocket tube 108 above the pilot parachute tube 110 (FIG. 1), those skilled in the art will appreciate that alterative orientations are within the scope of the invention.

The rocket tube 108 and the pilot parachute tube 110 may be disposed distally of the vertical stabilizer 120 and tail rotor 130. The safety achieved by this design is a combination of the distal mounting of the rocket tube 108 and the pilot parachute tube 110 and a relatively short length of jettison cable attached to a pilot chute as further described herein. This design ensures that the tail rotor 130 will not interfere with the deployment of the pilot parachute (not shown) as further described herein.

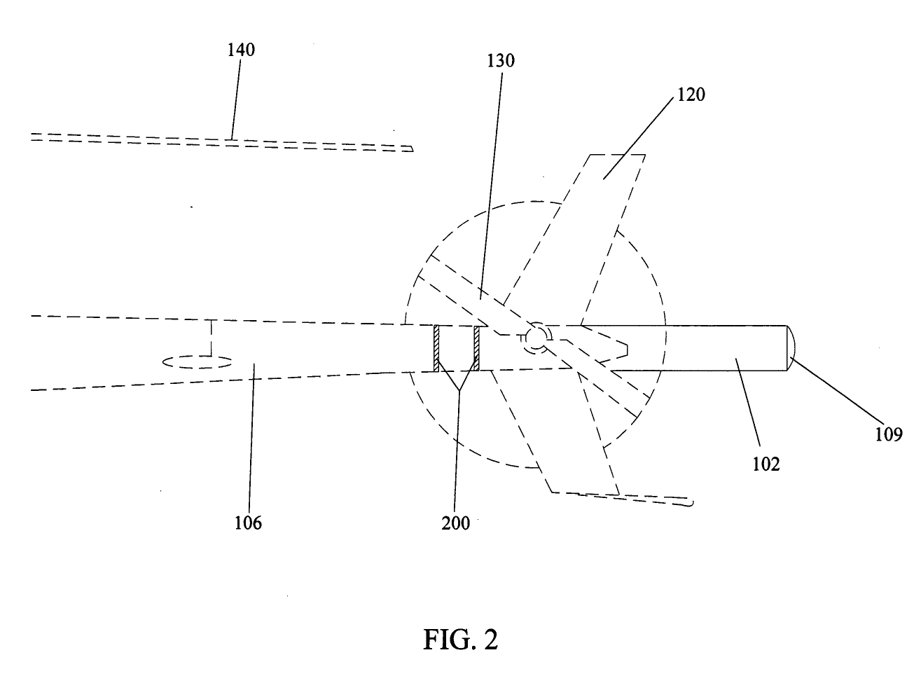

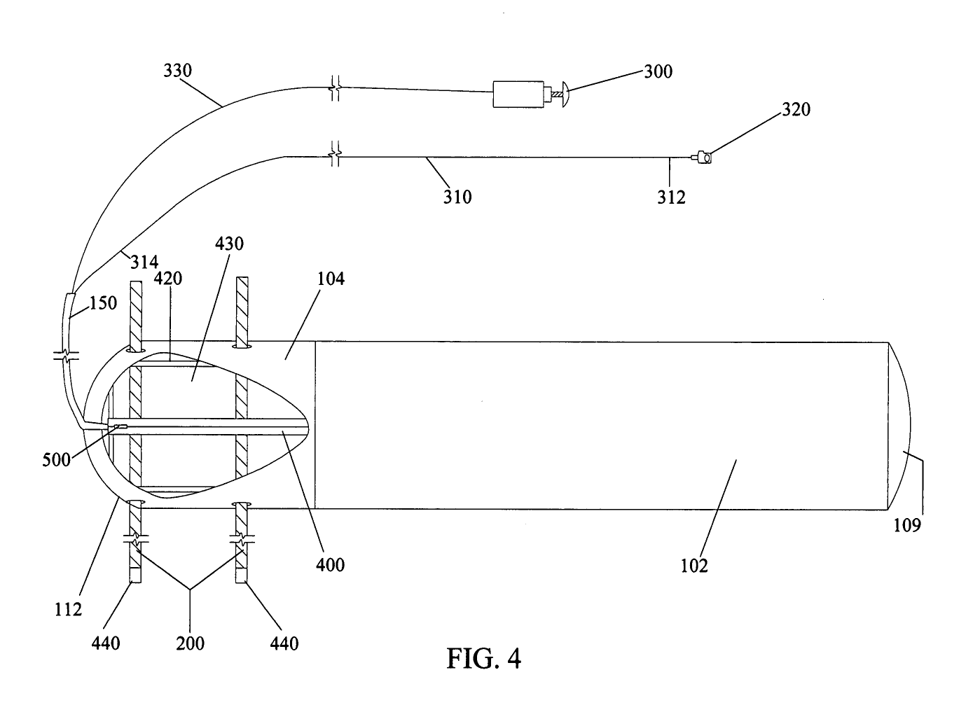

With reference to FIG. 2, the elongated main parachute housing 102 is shown strapped to the helicopter tail boom 106 by straps 200. The arrangement of straps 200 will be further described with reference to FIG. 4.

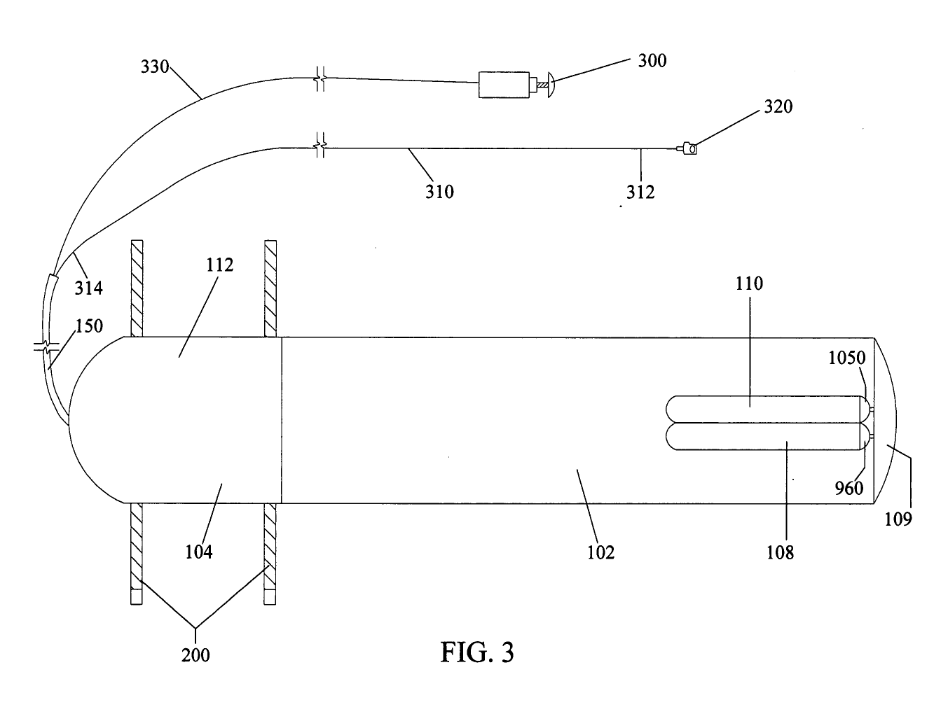

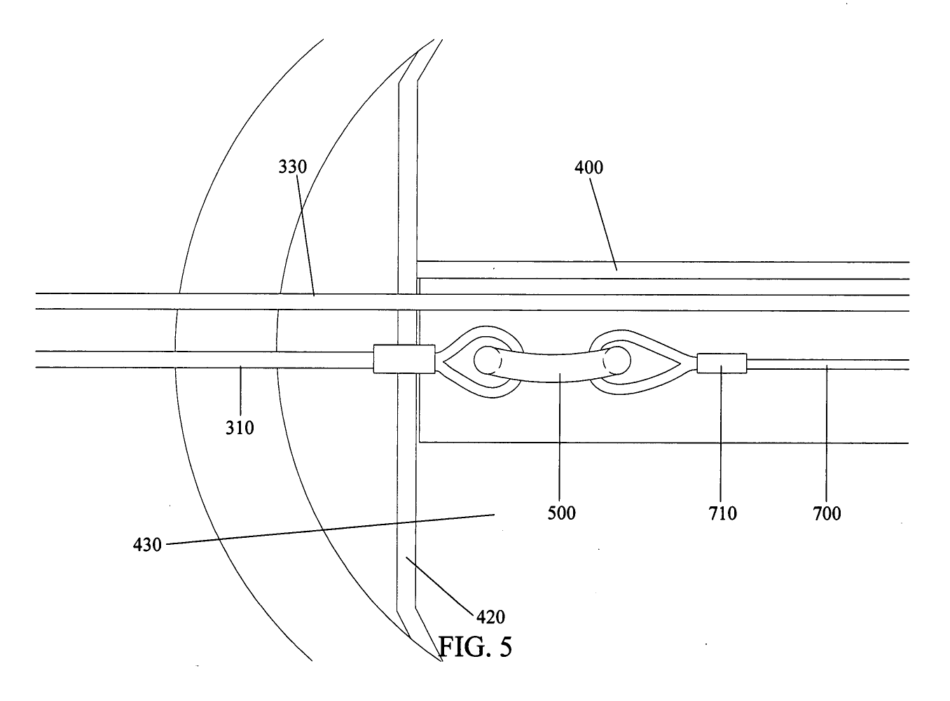

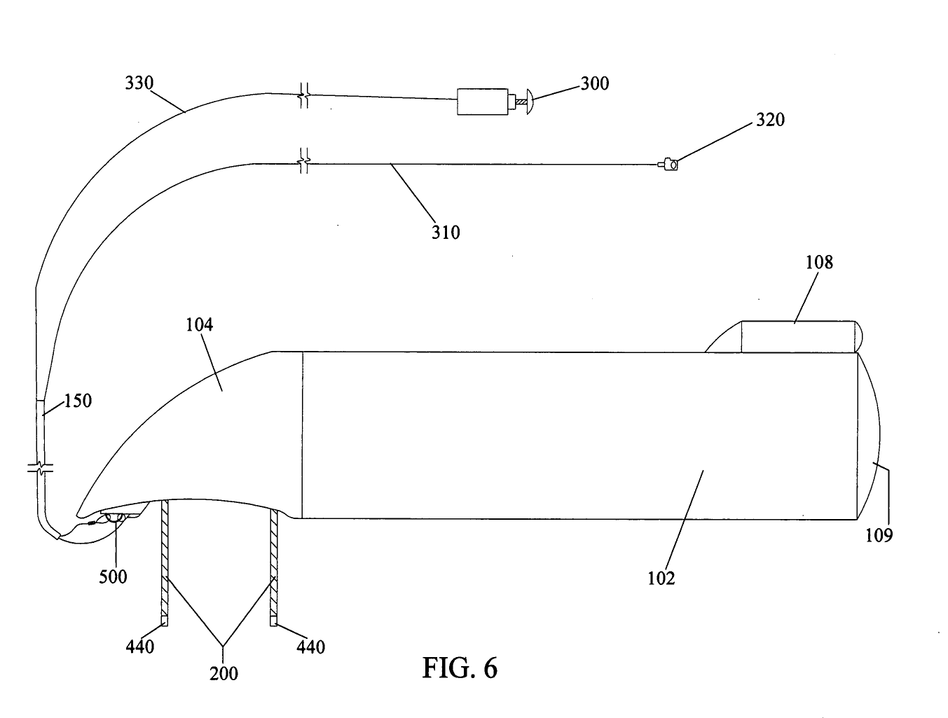

The operation of the emergency parachute system for helicopters 100 may be controlled by control cables 330 shown in FIG. 3. A handle mechanism 300 may be operably attached to control cables 330 to operate the emergency parachute system for helicopters 100 as further described herein. A safety cable 310 may be secured at a first end 312 to a frame clamp 320 which in turn may be secured to a helicopter frame (not shown) and at a second end 314 to a support bar 400 as shown in FIGS. 4 and 5. The safety cable 310 provides a direct link between the helicopter frame and the main parachute (not shown) in the event the helicopter's tail boom 106 is severed and/or the emergency parachute system 100 comes away from the tail boom 106 as in a case where the straps 200 snap. Sheath 150 may enclose control cables 330 and safety cable 310 proximate the second end portion of the main parachute housing 112 and enter the main parachute tube 102 through a main parachute housing aperture 430. Sheath 150 may be made from a strong protective material such as Kevlar-surrounded steel to protect control cables 330 and safety cable 310 from a boom strike.

Support bar 400 may be formed from a rigid metal or the like. Support bar 400 may extend the length of the main parachute tube 102 and provide structural support to the main parachute tube 102. Support bar 400 may additionally guide control cable 330 as further described herein. Safety cable second end 314 may be secured to the support bar 400 at a ring connector 500 in a manner well known in the art.

With reference to FIG. 4, an internal frame 420 may be attached to support bar 400. Straps 200 may extend around an outside of frame 420 and around the helicopter tail boom 106 to secure the main parachute tube 102 to the helicopter tail boom 106. Straps 200 may be provided with buckles 440 for attachment of straps 200.

With reference to FIGS. 5 and 7, the frame 420 is shown disposed inside the fairing 104. Support bar 400 may extend along a length of the main parachute tube 102. Dynamic riser 700 may be attached at a first end 710 to ring connector 500 (FIG. 5) and at a second end 720 to main parachute 750. In an alternative embodiment, support bar 400 and frame 420 are not employed and a high strength composite material is used to fabricate the main parachute tube 102.

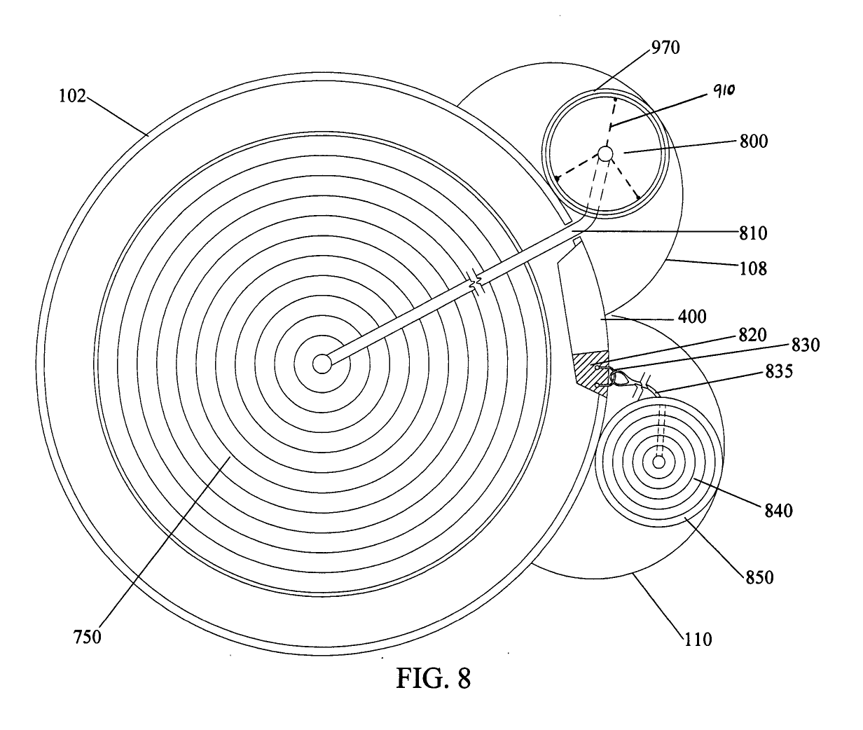

With reference to FIG. 8, main parachute 750 may be coupled to a rocket 800 disposed in rocket tube 108. Main parachute 750 may be coupled to the rocket 800 by means of a dynamic lanyard 810. The operation of rocket 800 will be further described with reference to FIG. 9.

A jettison device 820 may be disposed adjacent support bar 400. Jettison device 820 may include a releasable ring 830 to which may be attached a jettison cable 835. Jettison cable 835 may be attached to pilot parachute 840 which may be disposed in a pilot parachute cylinder 850 in pilot parachute tube 110. Pilot parachute 840 may include a conventional parachute or some type of high-drag device. If a conventional parachute is employed as the pilot parachute 840 a canopy thereof may be semi-rigid in order that the pilot parachute 840 stays open in the helicopter's slip stream regardless of turbulence. Pilot parachute 840 is jettisoned

With reference to FIG. 9 dynamic lanyard 810 may couple main parachute 750 to rocket 800 by attachment to main parachute 750 at a main parachute ring 900 and attachment to rocket 800 at a plurality of points 910. Dynamic lanyard 810 may extend from main parachute 750 to rocket 800 through rocket tube cylinder 970.

Rocket 800 is deployed by ignition of an ignition primer 920 in a manner well known in the art. Ignition primer 920 is ignited by operation of rocket control cable 930 as further described herein. Control cables for the deployment and jettison of the pilot parachute 840 (1030 on FIG. 10 and 821 on FIG. 9, respectively) may be disposed along support bar 400. Rocket 800 launches from a platform 950 disposed inside rocket tube cylinder 970 and may be protected inside rocket tube 108 by rocket tube cap 960.

With reference to FIG. 10 pilot parachute 840 may be coupled to jettison device 820 by jettison cable 835 which may extend from pilot parachute 840 to jettison device 820 through pilot parachute tube cylinder 850. Pilot parachute 840 may include an articulating hinge 1000 releaseably coupled to a spring loaded release mechanism 1010. Release mechanism 1010 may be supported by a platform 1020. A pilot chute control cable 1030 may be operably coupled to the release mechanism 1010 to release pilot parachute 840. Pilot parachute 840 may be protected inside pilot parachute tube 110 by pilot parachute tube cap 1050.

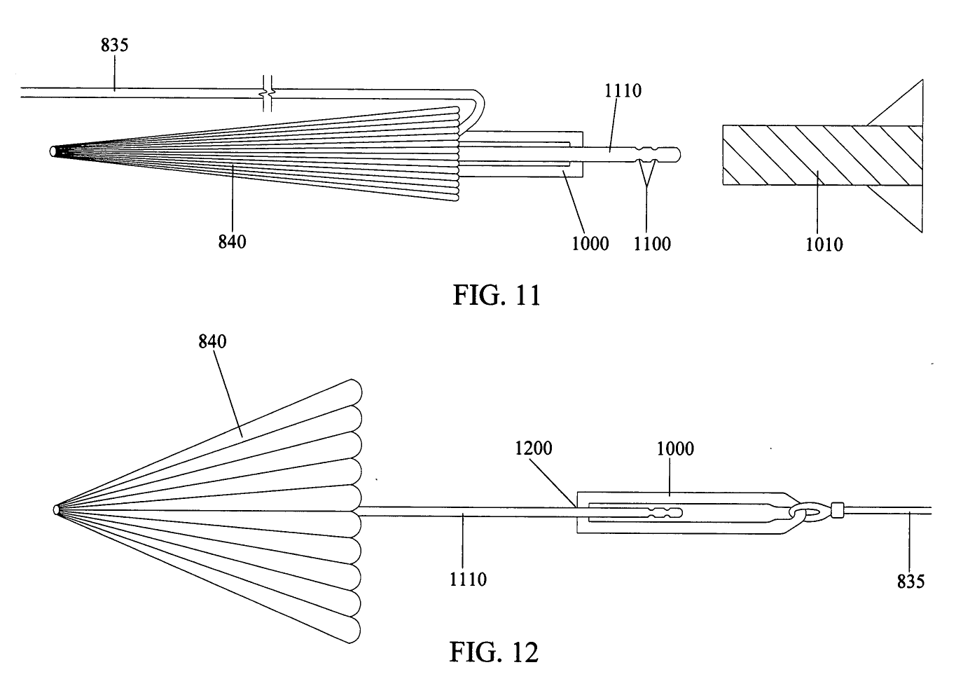

FIGS. 11 and 12 illustrate the deployment of pilot parachute 840. With reference to FIG. 11 a pilot parachute shaft 1110 may include locking grooves 1100 engageable within release mechanism 1010. Operation of pilot chute control cable 1030 (FIG. 10) may release pilot parachute shaft 1110 from release mechanism 1010 as shown in FIG. 11.

With reference to FIG. 12 once pilot parachute 840 is released from release mechanism 1010 articulating hinge 1000 pivots about pivot point 1200 and pilot parachute 840 may remain attached to jettison device 820 (FIG. 10) by means of jettison cable 835.

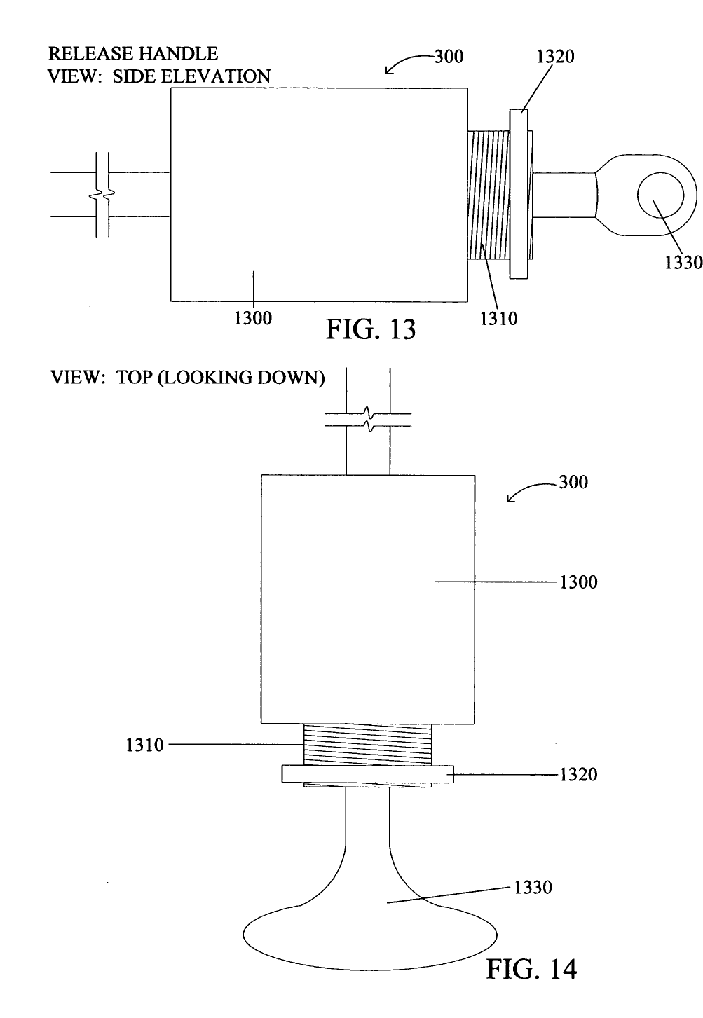

With reference to FIGS. 13 and 14 three-function handle 300 may include a housing 1300 having at one end a threaded shaft 1310 and lock nut 1320. A control handle 1330 may be operable to engage control cables 330 as further described herein.

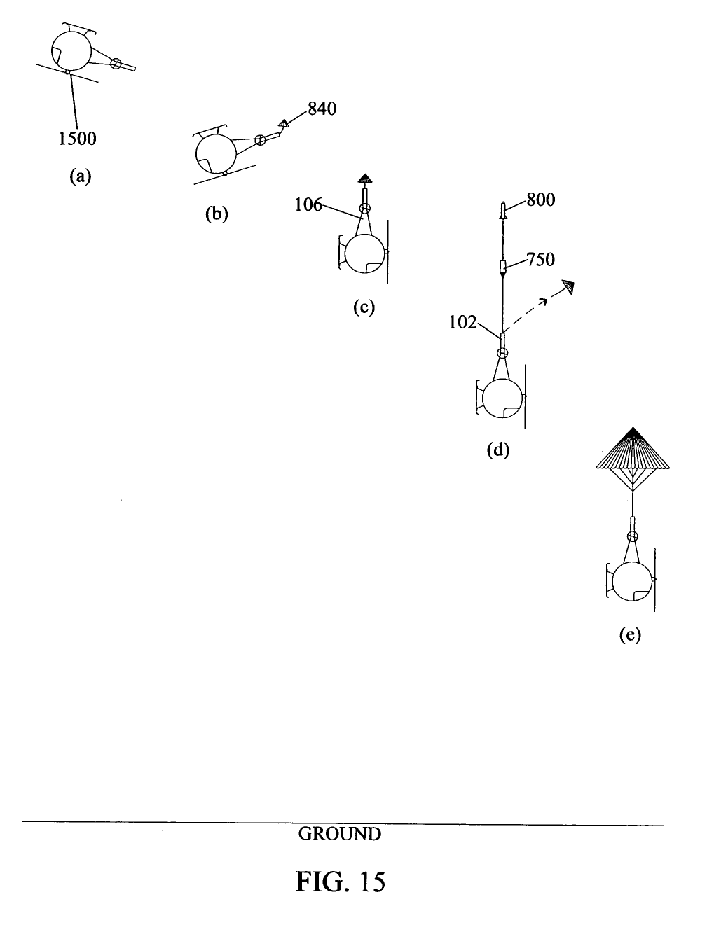

Operation of the emergency parachute system for helicopters 100 will now be described. With reference to FIG. 15 in an emergency condition in which a helicopter 1500 cannot be controlled by a helicopter pilot as shown in (a), the helicopter pilot may use the handle 300 in a first position to deploy pilot parachute 840 as shown in (b). Once the helicopter 1500 is positioned such that the tail boom 106 is pointed upward as shown in (c) the pilot may use the handle 300 in a second position to release pilot parachute 840 as shown in (d). The pilot may then immediately deploy rocket 800 as shown in (d) using a third position of handle 300. Deployment of rocket 800 draws main parachute 750 from main parachute tube 102 whereupon main parachute 750 opens as shown in (e). As will be appreciated by those skilled in the art, handle 300 may be replaced by alternative means of deploying pilot parachute 840, releasing pilot parachute 840 and deploying rocket 800. Further, an airbag (not shown) may be disposed on a nose of the helicopter 1500 and deployed when the main parachute 750 opens to soften the landing of the helicopter 1500.

As shown, the emergency parachute system for helicopters overcomes the deficiencies of the prior art by providing a deployable pilot parachute and a rocket deployed main parachute, the system being disposed on a tail boom of a helicopter distal of the main rotor and tail rotor. It should be understood, of course, that the foregoing relates to preferred embodiments of the invention and that modifications may be made without departing from the spirit and scope of the invention. Any such modifications should in no way limit the scope of the invention, which should only be determined based on the following claims.

1. An emergency parachute system for helicopters comprising:
a main parachute tube attached to a helicopter tail boom distal of a helicopter main rotor and tail rotor, the main parachute tube housing a main parachute;
a rocket tube housing a rocket, the rocket tube disposed on the main parachute tube, the rocket attached to the main parachute;
a pilot parachute tube housing a pilot parachute, the pilot parachute tube disposed on the main parachute tube, the pilot parachute attached to the tail boom; and
control means for deploying the pilot parachute and the rocket.

2. The emergency parachute system for helicopters of claim 1, wherein the main parachute tube is attached to by means of a strap.

3. The emergency parachute system for helicopters of claim 1, wherein the main parachute tube comprises a frame.

4. The emergency parachute system for helicopters of claim 1, wherein the main parachute tube comprises a support bar extending along a length thereof.

5. The emergency parachute system for helicopters of claim 1, wherein the main parachute tube comprises a fairing.

6. The emergency parachute system for helicopters of claim 1, wherein the main parachute is attached to a helicopter frame.

7. The emergency parachute system for helicopters of claim 1, wherein the main parachute tube comprises a cap disposed at a second end portion of the main parachute tube.

8. The emergency parachute system for helicopters of claim 7, wherein the rocket tube and pilot parachute tube are disposed proximate the second end portion.

9. The emergency parachute system for helicopters of claim 1, wherein the rocket tube and pilot parachute tube are disposed distally of a helicopter vertical stabilizer and tail rotor.

10. The emergency parachute system for helicopters of claim 1, wherein the control means for deploying the pilot parachute and the rocket comprise control cables.

11. The emergency parachute system for helicopters of claim 10, wherein the rocket is controllable by means of a rocket control cable.

12. The emergency parachute system for helicopters of claim 10, wherein the deployment of the pilot parachute is controllable by means of a pilot parachute deployment control cable.

13. The emergency parachute system for helicopters of claim 10, wherein the pilot parachute is attached to the tail boom by means of a jettison cable attached to a jettison device, jettison device controllable by means of a jettison control cable.

14. The emergency parachute system for helicopters of claim 1, wherein the control means for deploying the pilot parachute and the rocket comprise electronic means.

15. A safety apparatus for use with a helicopter having a frame, a tail boom, a main rotor, a vertical stabilizer, and a tail rotor, the apparatus comprising:
a main parachute tube attached to the helicopter tail boom distal of the helicopter main rotor and tail rotor, the main parachute tube housing a main parachute;
a rocket tube housing a rocket, the rocket tube disposed on the main parachute tube distal of the vertical stabilizer and tail rotor, the rocket attached to the main parachute;
a pilot parachute tube housing a pilot parachute, the pilot parachute tube disposed on the main parachute tube distal of the vertical stabilizer and tail rotor, the pilot parachute attached to the frame; and
a control cable for deploying the pilot parachute, a control cable for releasing the pilot parachute, and a control cable for deploying the rocket.

16. A method of providing safety to a helicopter having a frame, a tail boom, a main rotor, a vertical stabilizer, and a tail rotor, the method comprising the steps of:
deploying a pilot parachute attached to the helicopter frame, the pilot parachute being attached distally of the helicopter main rotor, vertical stabilizer and tail rotor;
releasing the pilot parachute when the helicopter tail boom is pointed upward relative to a falling direction; and
deploying a rocket attached to a main parachute, the main parachute being attached to the helicopter frame.
